(19) United States
(12) Patent Application Publication
(10) Pub. No.: US 2007/0135116 A1
(43) Pub. Date: Jun. 14, 2007

(54) WIRELESS COMMUNICATION SYSTEM FOR SENDING RESCUE MESSAGE AND MANAGING METHOD THEREOF

(76) Inventor: CHI-WEN CHEN, Taoyuan (TW)

Correspondence Address: HOFFMAN WARNICK & D'ALESSANDRO, LLC, 75 STATE STREET, 14TH FLOOR, ALBANY, NY, 12207, US

(21) Appl. No.: 11/609,385

(22) Filed: Dec. 12, 2006

(30) Foreign Application Priority Data
Dec. 12, 2005 (TW) 094143873

(51) Int. Cl. H04Q 7/20

(52) U.S. Cl. 455/422.1

(57) ABSTRACT

A method for sending rescue messages in a wireless communication system is provided. The wireless communication system includes a base station, a first mobile station, and a second mobile station. The base station has a communication zone, and the first mobile station is outside the communication zone. According to this invention, the first mobile station first broadcasts a first rescue request. Once receiving the first rescue request, the second mobile station generates a second rescue request based on the first rescue request and stores the second rescue request in the second mobile station. Once being in the communication zone, the second mobile station then transmits the second rescue request to the base station.

### BACKGROUND OF THE INVENTION

1. Field of the Invention

This invention is related to a method for sending messages and, more specifically, to a method for sending rescue messages in a wireless communication system.

2. Description of the Prior Art

Due to the rapid growth of wireless communication and electronic industries, mobile phones have become essential personal equipment for modern people, no matter in daily life or work. Besides daily communications, mobile phones can also be used for transmitting rescue messages. Victims can ask for help or assistance through mobile phones.

However, owing to the limitation of costs and utility rates, the number of base stations and communication zones provided by base stations are both limited. Typically, when users are in more desolate mountains, signals between their mobile phones and base stations are weak or even zero; users may be unable to connect with others through mobile phones. Once an emergency occurs, if a climber's mobile phone is unfortunately outside the communication zones of neighboring base stations, the climber can only wait for rescue passively. This kind of conditions may cause serious casualties and lower the chance of victims being rescued. Therefore, overcoming problems in communications and raising efficiencies of rescuing are important issues.

### SUMMARY OF THE INVENTION

The present invention provides a wireless communication system for sending rescue messages and managing methods thereof. According to this invention, rescue messages can be transmitted between mobile stations without a base station. Because the total number and probable distribution zones of mobile stations are larger than those of base stations, even if a mobile station that sends rescue requests is outside communication zones of base stations, the mobile station may send the rescue requests to some base stations via the other neighboring mobile station. After receiving the rescue requests, the base stations can immediately inform local rescue units to search for the user sending the rescue requests.

The wireless communication system, according to this invention, includes a base station that has a communication zone, a first mobile station, and a second mobile station. The first mobile station is assumed to be outside the communication zone.

In one preferred embodiment, according to this invention, when the first mobile station broadcasts a first rescue request, once receiving the first rescue request, the second mobile station generates a second rescue request based on the first rescue request. The second mobile station then stores the second rescue request that is relative to the first rescue request in the second mobile station. Once being in the communication zone of the base station, the second mobile station transmits the second rescue request to the base station.

In another preferred embodiment, according to this invention, when the first mobile station is out of connection with others, the base station can initiate to broadcast a searching request. Once the second mobile station receives the searching request broadcasted by the base station, the second mobile station also broadcasts the searching request. Once receiving the searching request broadcasted by the second mobile station, the first mobile station then broadcasts the first rescue request.

The advantage and spirit of the invention may be understood by the following recitations together with the appended drawings.

### BRIEF DESCRIPTION OF THE APPENDED DRAWINGS

FIG. 1 illustrates one preferred embodiment according to this invention.

FIG. 2 illustrates the flowchart of one preferred embodiment according to this invention.

FIG. 3 illustrates another preferred embodiment according to this invention.

### DETAILED DESCRIPTION OF THE INVENTION

One main purpose of the present invention is to provide a wireless communication system for sending rescue messages and managing methods thereof.

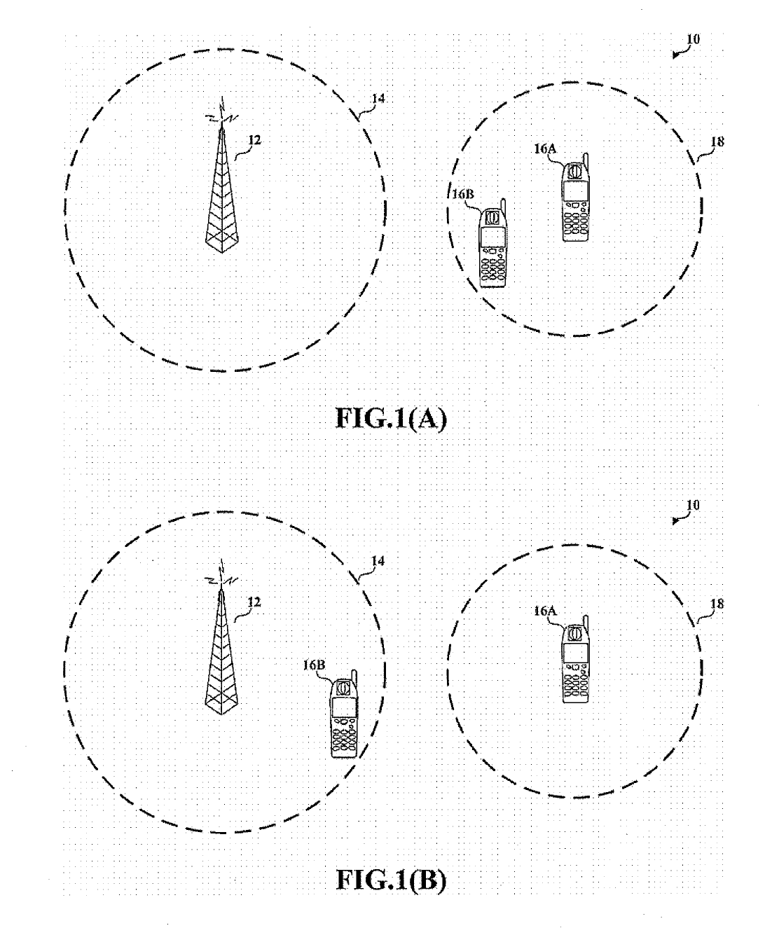

Please refer to FIG. 1. A wireless communication system 10, according to this invention, includes a base station 12 that has a communication zone 14, a first mobile station 16A, and a second mobile station 16B. The first mobile station 16A is assumed to be outside the communication zone 14.

In one preferred embodiment, according to this invention, when the user of the first mobile station 16A encounters an emergency and needs to ask for help, the user can broadcast a first rescue request from the first mobile station 16A over a broadcast control channel (BCCH) or other channels having broadcasting functions. In actual applications, the first rescue request may include location information, an image, an audio record, or text related to the first mobile station 16A, so that rescue staff can definitely know where the user is or what the user needs. The location information can be generated by a position system externally connected with the first mobile station 16A, such as GPS equipment. The image can be generated by a camera externally connected with the first mobile station 16A. In that image, surrounding conditions of the user can be shown, such as some obvious landmarks or the current status of the user. The audio record can be a file generated by a recorder externally connected with the first mobile station 16A.

As shown in FIG. 1(A), once the second mobile station 16B enters a zone 18 which can receive the first rescue request broadcasted by the first mobile station 16A, or if the second mobile station 16B is already in the zone 18, the second mobile station 16B will receive the first rescue request. The second mobile station 16B can then generate a second rescue request based on the first rescue request and store the second rescue request in the second mobile station 16B. Besides all the information included in the first rescue request, the second rescue request can further include location information, an image, or an audio record related to the second mobile station 16B. In this way, rescue staff can judge where the user of the first mobile station 16A is, according to the information provided in the second rescue request. Furthermore, the second mobile station 16B can show a message for reminding the user of the second mobile station 16B to enter communication zones of adjacent base stations as soon as possible, so as to transmit the rescue requests to rescue organizations.

As shown in FIG. 1(B), after receiving the first rescue request and once being in the communication zone 14 of the base station 12, the second mobile station 16B immediately transmits the second rescue request to the base station 12. After receiving the second rescue request, the base station 12 can subsequently inform neighboring rescue organizations to search for the user of the first mobile station 16A.

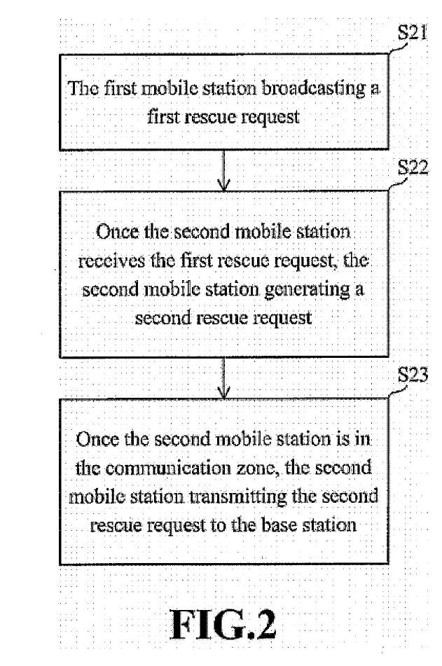

Please refer to FIG. 2, which illustrates the flow chart of the aforementioned embodiment.

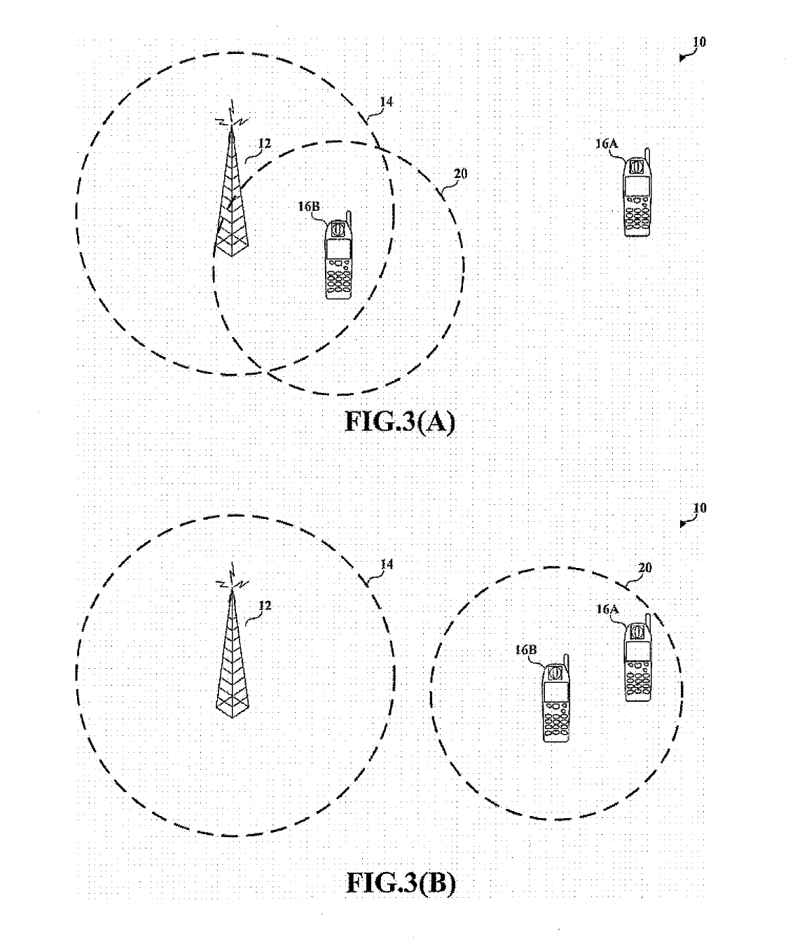

In another preferred embodiment, according to this invention, when official or civil rescue organizations ask communication companies to send a rescue message, the base station 12 can initiate to broadcast a searching request. The searching request informs neighboring mobile stations to transmit the request for searching the first mobile station 16A. As shown in FIG. 3(A), the second mobile station 16B is assumed to be inside the communication zone 14 of the base station 12. Once receiving the searching request broadcasted by the base station 12, the second mobile station 16B broadcasts the searching request, too. The range 20 represents a zone in which other mobile stations can receive the searching request broadcasted by the second mobile station 16B. As shown in FIG. 3(B), if the second mobile station 16B is then moved to the neighborhood of the first mobile station 16A, so that the first mobile station 16A is inside the zone 20 and receives the searching request broadcasted by the second mobile station 16B, the first mobile station 16A can then broadcast the aforementioned first rescue request to show that it is the one being searched.

In actual applications, before the first mobile station 16A receives the searching request, the battery power of the first mobile station 16A may be lower than a predetermined threshold. To save power, the first mobile station 16A can stop broadcasting the first rescue request and can operate to only receive signals. Not only until receiving the searching request broadcasted by the second mobile station 16B that the first mobile station 16A actively responses to the searching request and starts to broadcast the first rescue request.

Furthermore, when having gotten enough information, the official or civil rescue organizations can ask the communication companies to stop broadcasting the rescue requests from the base station 12.

According to this invention, rescue messages can be transmitted between mobile stations without a base station. Because the total number and probable distribution zones of mobile stations are larger than those of base stations, even if a mobile station that sends rescue requests is outside communication zones of base stations, the mobile station may send the rescue requests to some base stations via the other neighboring mobile stations. Thus, this invention can overcome the inconvenient problems of communications in prior arts and raise efficiencies of rescuing.

With the example and explanations above, the features and spirits of the invention will be hopefully well described. Those skilled in the art will readily observe that numerous modifications and alterations of the device may be made while retaining the teaching of the invention. Accordingly, the above disclosure should be construed as limited only by the metes and bounds of the appended claims.

What is claimed is:

1. A method for sending rescue messages in a wireless communication system, the wireless communication system comprising a base station, a first mobile station, and a second mobile station, the base station having a communication zone, the first mobile station being outside the communication zone, said method comprising:
the first mobile station broadcasting a first rescue request;
once receiving the first rescue request, the second mobile station generating a second rescue request based on the first rescue request and storing the second rescue request in the second mobile station; and
once being in the communication zone, the second mobile station transmitting the second rescue request to the base station.

2. The method of claim 1, wherein the first rescue request comprises one of location information, an image and an audio record related to the first mobile station.

3. The method of claim 1, wherein the second rescue request comprises one of location information, an image and an audio record related to the second mobile station.

4. The method of claim 1, wherein the first rescue request is broadcasted over a broadcast control channel (BCCH).

5. The method of claim 1, said method further comprising:
the base station broadcasting a searching request;
once receiving the searching request broadcasted by the base station, the second mobile station broadcasting the searching request; and
once receiving the searching request broadcasted by the second mobile
station, the first mobile station broadcasting said first rescue request.

6. The method of claim 5, wherein the searching request is broadcasted over a broadcast control channel (BCCH).

7. The method of claim 5, said method further comprising:
before the first mobile station receives the searching request, once a battery power of the first mobile station is lower than a predetermined threshold, the first mobile station stopping broadcasting the first rescue request and operating to only receive signals; and
once receiving the searching request, the first mobile station broadcasting the first rescue request.

8. A wireless communication system, comprising:
a base station having a communication zone;
a first mobile station outside the communication zone, wherein once a user sets the first mobile station into an emergency mode, the first mobile station broadcasts a first rescue request; and
a second mobile station, once receiving the first rescue request, the second mobile station generating a second rescue request based on the first rescue request and storing the second rescue request, and once being in the communication zone of the base station, the second mobile station transmitting the second rescue request to the base station.

9. The wireless communication system of claim 8, wherein once the base station broadcasts a searching request and the second mobile station receives the searching request broadcasted by the base station, the second mobile station broadcasts the searching request, and once receiving the searching request broadcasted by the second mobile station, the first mobile station broadcasts said first rescue request.

10. The wireless communication system of claim 8, wherein the first rescue request comprises one of location information, an image, and an audio record related to the first mobile station.

11. The wireless communication system of claim 8, wherein the second rescue request comprises one of location information, an image, and an audio record related to the second mobile station.

12. The wireless communication system of claim 8, wherein the first rescue request is broadcasted over a broadcast control channel (BCCH).

13. The wireless communication system of claim 13, wherein the searching request is broadcasted over a broadcast control channel (BCCH).
